(19) United States
(12) Patent Application Publication
(10) Pub. No.: US 2002/0142241 A1
(43) Pub. Date: Oct. 3, 2002

(54) Microencapsulated electrophotographic toner particles having colored shells

(76) Inventor: Donald J. Palmer, Eagle, ID (US)

Correspondence Address: HEWLETT-PACKARD COMPANY, Intellectual Property Administration, P.O. Box 272400, Fort Collins, CO, 80527-2400, US

(21) Appl. No.: 09/803,063

(22) Filed: Mar. 7, 2001

(51) Int. Cl. G03G 9/093; B05C 5/02

(52) U.S. Cl. 430/110.2; 118/624; 118/621

(57) ABSTRACT

Microencapsulated electrophotographic toner particles are provided with a shell that, upon rupture, substantially determines the color of the image produced by such particles.

### BACKGROUND OF THE INVENTION

1. Technical Field

This invention relates to electrophotographic printers. Such printers generally operate by forming an electrical latent image, developing that latent image with a toner, transferring the resultant toner image onto a transfer substrate such as a sheet of paper and then fixing the toner image on the transfer substrate by means of pressure, heat, etc. This invention is particularly concerned with the use of microencapsulated toner particles in such electrophotographic printers in order to produce colored images.

2. Description of Related Art

Many electrophotographic toner compositions employ microcapsule components that are comprised of a polymeric shell that surrounds a core material that includes: (1) polymer binder compositions, (2) magnetizable materials and (3) colorants (pigments, dyes or mixtures thereof). For example, U.S. Pat. No. 4,803,144 teaches use of encapsulated, electrostatographic toner particles having a pressure rupturable shell that encapsulates a pressure fixable adhesive core material that also contains a colorant and a magnetizable substance. The outer surface of the shell also is provided with a white electroconductive powder.

U.S. Pat. No. 4,476,211 (“the '211 patent”) also discloses a pressure fixing process whose toner particles are provided with a colored electroconductive powder on the outer surface of the toner capsules. Such a colored electroconductive powder (e.g., carbon black and colloidal graphite) are spray dried on to the toner particles together with a wet toner dispersion material.

The methods by which toner particle core materials have been microencapsulated by a shell material vary considerably. For example, so-called “interfacial polymerization” methods are described in U.S. Pat. Nos. 3,577,515, and 3,429,827. So-called “inner polymerization” methods are described in U.S. Pat. Nos. 3,660,304, 3,726,804, 3,796,669 and 2,969,330. “Phase separation” methods are described in U.S. Pat. Nos. 2,800,457, 2,800,458, 3,041,289, and 3,205,175. Various “outer polymerization” methods are described in U.S. Pat. Nos. 4,087,376, 4,089,802, 3,100,103, and 4,001,140. Several “fusion-dispersion-cooling” methods are described in U.S. Pat. No. 3,167,602.

A survey of the teachings of such patents also suggests that placement of colorant materials inside a microcapsule's polymeric shell have created certain problems that have not been completely recognized and/or solved. For example, the fix level of a developed image made from encapsulated toner particles by heat and pressure fixing methods is generally dependent on the rate of, and extent of, diffusion of the adhesive/colorant components that are “squeezed out” of a ruptured microcapsule. These adhesive/colorant components have two major functions. The adhesive component must fix to the paper (or other substrate) and the colorant component must present itself to the view of a human observer. The initial fix, that is the fix level in the first minute or so after shell rupture (especially under low fixing pressures of about 2,000 psi) is usually only about 5 to about 30 percent. To some degree, these low initial fix levels follow from the fact that some of the core components are primarily concerned with carrying out chemical reactions involving the dyes and/or pigments released when the shell is ruptured—rather than the chemical and/or physical reactions needed to fix the ruptured microcapsule to the substrate. That is to say that in many microcapsule-employing toner systems, in order to present itself to human view, the colorant must chemically react with a core ingredient (e.g., an adhesive resin or other auxiliary core compound or composition) under the exposed (i.e., ruptured shell) conditions and that these color-producing chemical reactions may inhibit the physico-chemical reactions needed to fix the adhesive to the print medium.

Applicant has developed microencapsulated toner particles that eliminate the need for chemical reactions between a dye or pigment (or any other ingredient of the microcapsule) in order to produce a desired color.

### SUMMARY OF THE INVENTION

The present invention provides microencapsulated, electrophotographic toner compositions that provide improved image qualities. These improvements are especially pronounced in the case of color printing by electrophotographic means. These improved image qualities follow from at least two aspects of the present invention. The first aspect is that the color of the shell of applicant's microencapsulated toner particles substantially determines the color of the image presented to human view. The second aspect is the microcapsule's core components are released from the coloring duties called for in prior art microencapsulated toner particles. Hence, the core components can be more specifically selected to carry out their adhesive or fixing duties. That is to say that a higher initial fixing of applicant's ruptured toner microcapsules can be accomplished by virtue of the fact that the core components of applicant's microcapsules are primarily devoted to fixing the toner to the paper—as opposed to also being devoted to (1) carrying out color-producing chemical reactions of core-based colorants and/or (2) preventing certain color degrading reactions between the colorant and the media (e.g., paper) upon which the ruptured microcapsule is placed. These two image-improving attributes are made possible by virtue of the fact that applicant places the color-imparting components of a electrophotographic toner microcapsule in its shell material rather than (1) in its core components, or (2) on the surface of the shell material as per the teachings of the '211 patent and the '144 patent.

In some of the more preferred embodiments of this invention, all or virtually all of the colorant component(s) of an electrophotographic toner microcapsule will be in the shell material itself. Since applicant's shell material does not need to enter into any color-producing chemical reactions, the color of the shell material will “be” the color of the image produced by the electrophotographic process. In other words, when a shell of applicant's microencapsulated toner particles is ruptured, the core resin ingredient(s) is (are) primarily concerned with fixing the ruptured shell (of an already predetermined color) to the paper or other substrate. For the purposes of this patent disclosure, the term “colored shell” can be taken to mean that one or more dyes and/or pigments are incorporated into the shell material so that, for the most part, the shell is the material that substantially imparts a given color to an image produced by that toner particle. Thus, the color of the image can be more closely controlled since the colorant used in making the shell material is not called upon to involve itself in a color-producing chemical reaction when the shell is ruptured. Nor is the colorant in the shell material of applicant's toner particles degraded by any chemical and/or physical reactions between the toner substrate (e.g., a sheet of paper) and the adhesive component of the microcapsule's core composition.

The electromagnetic toner microcapsules of the present invention can be ruptured by pressure, heat, microwave energy, pH, light, radiation, ultrasound and combinations thereof, in order to release the core material (e.g., the binder, magnetic particles, etc.) within the microcapsule shell on to a substrate such as a piece of paper. Preferably the core material is a liquid or semi-liquid binder material that is released when the shell is ruptured. In effect, the hard, colored shells are “glued down” to the substrate by the binder material when applicant's microcapsules are ruptured.

### BRIEF DESCRIPTION OF THE DRAWINGS

FIG. 1 is a cross sectional view of a microencapsulated toner particle made according to a first prior art method.

FIG. 2 is a cross sectional view depicting the results of rupturing the toner particle shown in FIG. 1.

FIG. 3 is a perspective view of the results of rupturing the toner particle shown in FIG. 1.

FIG. 4 is a cross sectional view of a microencapsulated toner particle made according to a second prior art method.

FIG. 5 is a cross sectional view depicting the results of rupturing the toner particle shown in FIG. 4.

FIG. 6 is a perspective view of the results of rupturing the toner particle shown in FIG. 4.

FIG. 7 depicts a cross sectional view of an embodiment of the present invention wherein an electrophotographic toner particle is comprised of a rupturable, colored shell that encapsulates a binder material having particles of magnetizable material dispersed therein.

FIG. 8 depicts a cross sectional view of the toner particle of FIG. 7 upon being ruptured and associated with a substrate material such as a sheet of paper.

FIG. 9 depicts a perspective view of the results of rupturing the electrophotographic toner particle shown in FIG. 7.

FIG. 10 depicts a cross sectional view of another embodiment of the present invention wherein an electrophotographic toner particle is comprised of a rupturable, colored shell that encapsulates a core binder material and wherein the rupturable, colored shell also has a magnetizable material disbursed therein.

FIG. 11 depicts a cross sectional view of the electrophotographic toner particle of FIG. 10 in a ruptured state and associated with a substrate material such as paper.

FIG. 12 is a perspective view of the results of rupturing the electrophotographic toner particle shown in FIG. 10.

### DETAILED DESCRIPTION OF THE INVENTION

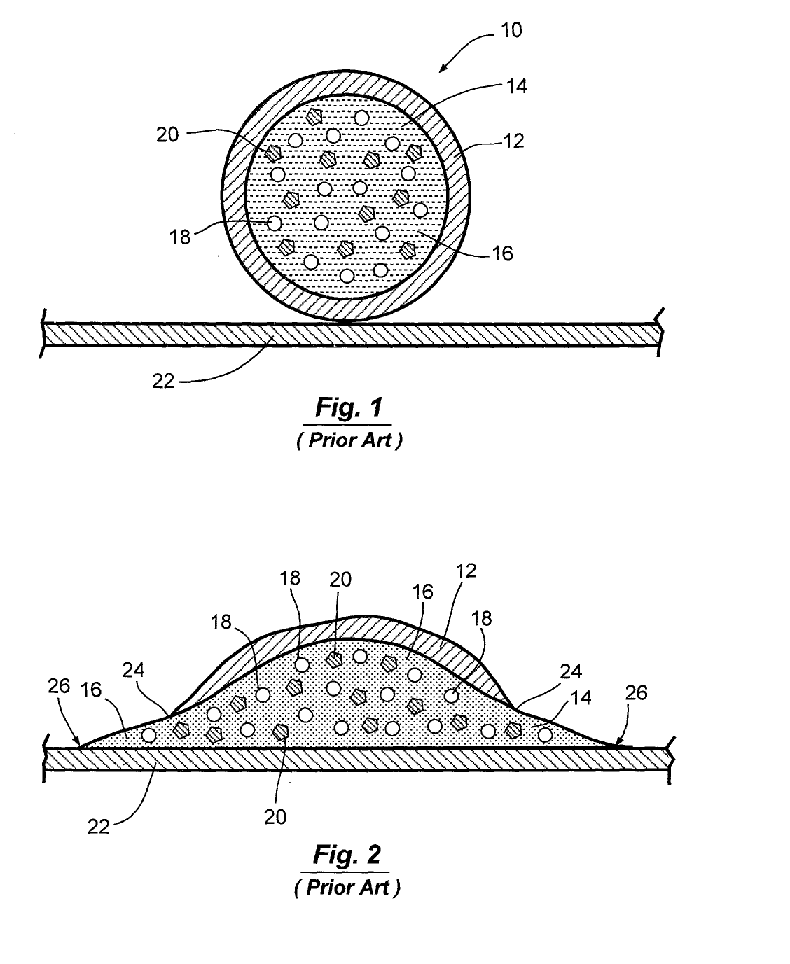

FIG. 1 depicts, in cross section, an electrophotographic toner microcapsule 10 made according to a prior art concept wherein said microcapsule 10 comprises a shell 12 that encapsulates a core composition 14. The core composition 14 is, in turn, comprised of one or more adhesive materials 16, color imparting dye and/or pigment components 18 and magnetic particles 20. This core composition 14 is normally in a liquid or semi-liquid state, especially when the shell 12 is ruptured. The microcapsule 10 is shown resting on a print media substrate 22 such as a sheet of paper. In general terms, the purpose of the shell 12 is to contain the core composition 14 until such time as its ingredients are deployed and affixed to a print media substrate in an electrophotographic printing process. The primary function of the adhesive material 16 is to fix a ruptured shell 12 and its core composition 14 to the substrate 22. Again, the core composition 14 of this prior art microcapsule includes a colorant 18 such as a dye or a pigment or both. Thus, the colorant 18 is “released” by rupture of the shell 12.

As was previously noted, many electrophotographic printing processes also involve carrying out desired chemical reactions between the dye or pigment and the adhesive material (or other ingredients mixed with the core material 14) upon rupture of the shell 12. Such electrophotographic printing process also often involve undesired chemical reactions between the dye or pigments, the adhesive material and/or the paper upon which the adhesive and dye components are placed by virtue of rupturing open the shell. Again, the core material 14 of electrophotographic toner particles also includes magnetically active materials 20. The function of these magnetically active materials 20 is to place or locate the microcapsule in a given place according to an electrical latent image produced by a electrophotographic printing process.

FIG. 2, in a highly generalized and idealized manner, depicts the prior art electrophotographic toner microcapsule of FIG. 1 in a ruptured state. Again, such a ruptured state can be produced by pressure, heat, microwave energy, pH, light, radiation, ultrasound and combinations thereof. In this ruptured state, the liquid or semi-liquid contents of the core composition 14 of the ruptured toner particle have spread out over a dot-like region of the substrate 22 and have begun the process of adhering to it. In this prior art electrophotographic process the liquid or semi-liquid contents of the core are shown spread out beyond the edge 24 of the remains of, or unbroken parts of, the shell 12. The contents of the core composition 14 include the color imparting material 18 (dye and/or pigment). Thus, only the contents of the core composition 14 that extend beyond the edge region 24 of any unbroken parts of the shell 12 to the outer perimeter 26 of the contents of the ruptured cell will impart a desired color to the ruptured shell system. In other words, only the dye or pigments in the core composition 14 that are released beyond the edge region 24 will impart a desired color to the overall ruptured cell system. To the extent that the dye or pigments enter into undesired chemical reactions with the other components of the core composition (under the ruptured cell conditions), or the paper 22, the color quality of the core composition 14 is diminished.

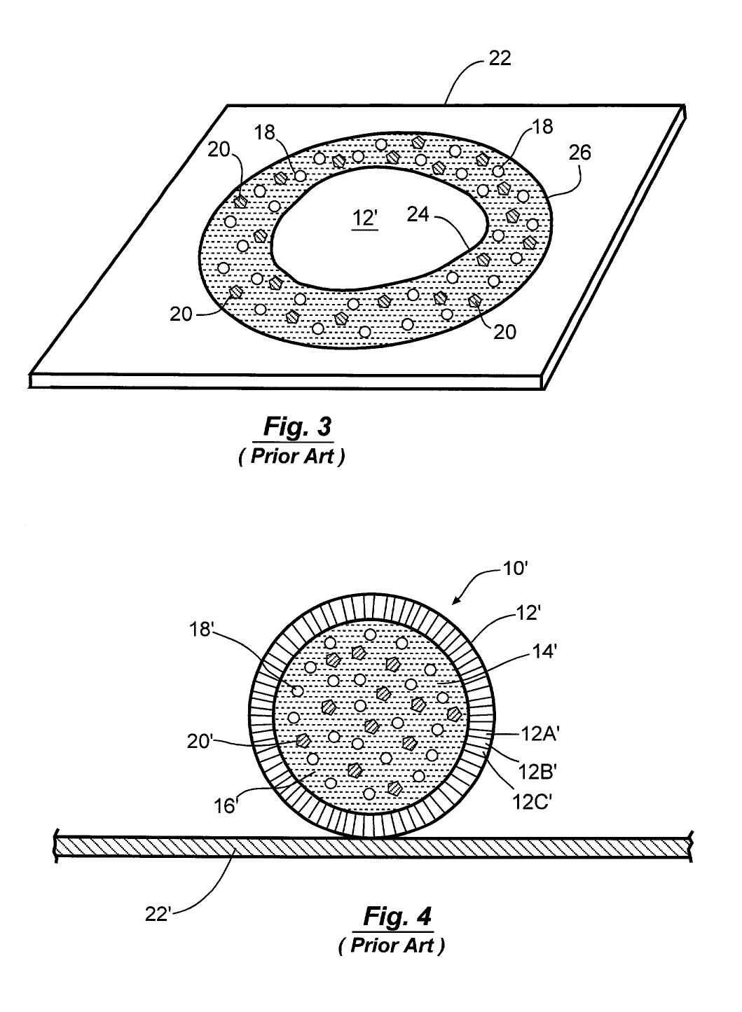

FIG. 3 is a perspective view of the ruptured shell system depicted in FIG. 2. It shows that the edge region 24 of the unbroken portion of the shell 12 encircled by a portion of the core composition 14 of the shell 12 shown in FIG. 1. This portion of the core composition extends from the edge region 24 of the shell 12 to the perimeter 26 of the ruptured shell system. It contains the color creating materials 18 of the core composition 14. It is this exposed portion of the core composition 14 that imparts the desired color to the body of materials that originally comprised the microcapsule. Thus, in this prior art system, the presence of the shell 12 on the upper center portion of the core composition 14 can detract from the color quality of the ruptured microcapsule depicted in FIG. 3. Moreover, the core composition materials 14 that lie between the ruptured shell's edge region 24 and the outer parameter 26 of the shell system are usually involved in desired (and undesired) chemical reactions that are difficult to control owing to changes in such variables as ambient temperature and relative humidity, moisture content of the paper (which effects its electrical resistivity) and the temperatures over which an electrophotographic printer varies as it processes a batch of paper.

FIG. 4 depicts, in cross section, a microcapsule 10′ made according to another prior art concept wherein a shell material 12′ again encapsulates a core composition 14′. The shell material is depicted as being comprised of subunits 12A′, 12B′, 12C′, etc. It should be understood that this physical depiction is an abstraction of a chemical concept rather than a physical one. That is to say that these subunits 12A′, 12B′, 12C′, etc. can be thought of as being chemical ingredients rather than an array of distinct physical particles that comprise the shell 12′. These chemical ingredients 12A′, 12B′, 12C′, etc. from which the shell 12′ is made are shown in this way to illustrate the fact that these chemical ingredients enter into chemical reactions with color producing ingredients 18 (e.g., dyes, pigments, etc.) in the core composition 14′ when the shell 12′ is ruptured. In any case, the core composition 14′ is again comprised of an adhesive material 16′, color imparting dye and/or pigment components 18′ and magnetic particles 20′. The microcapsule 10′ is again shown resting on a substrate 22′ such as a sheet of paper.

Thus, in this system, the shell 12′ once again contains the core composition 14′, but in this system the shell 12′ is made of chemical components 12A′, 12B′, 12C′ that enter into chemical reactions with one or more core composition components. That is to say that the shell materials 12A′, 12B′, 12C′, etc. are “used up” in chemical reactions with a core composition ingredient when the shell 12′ is broken. Again, one such core composition 14′ ingredient can be a color imparting material 18′ such as a dye or a pigment or both. And, here again, the function of the magnetic particles 20′ in this system is to place the toner microcapsule 10′ in a given place according to an electrical latent image produced by an electrophotographic printing process. The core composition 14′ may also include other components (usually polymers) that enter into a chemical reaction with the chemicals 12A′, 12B′, 12C′ from which the shell 12′ is made. Thus, the shell ingredients are used up in a chemical reaction with certain core composition ingredient(s) when the shell is exposed to the energy or other factors (e.g., heat, pressure, microwave, pH changes, etc.) used to rupture the shell.

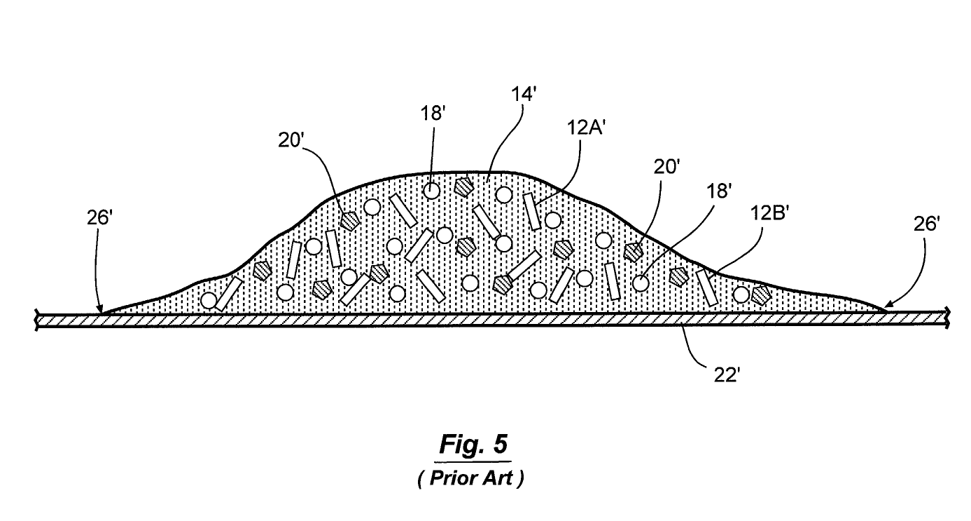

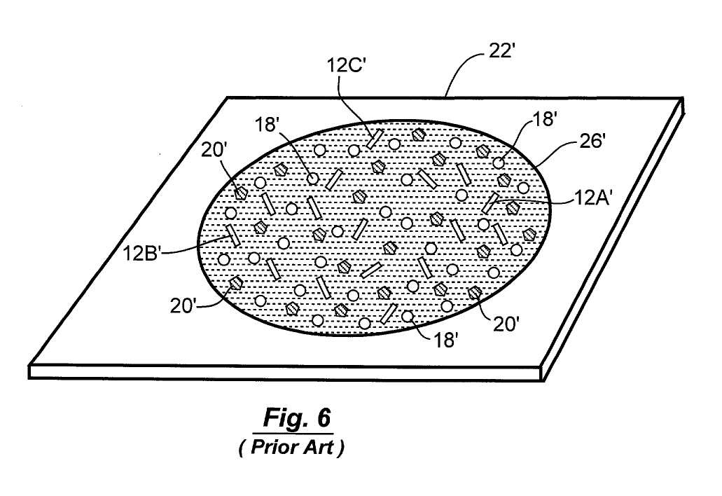

FIG. 5 depicts the toner microcapsule of FIG. 4 in a ruptured state. In this ruptured state, the contents of the core have spread out over a portion of the substrate 22′ and have begun the process of adhering to it. In this system, the liquid contents of the core composition 14′ have spread out to the edges 26′ of the mound of material produced by the shell rupture. The contents of the core composition can be thought of as having been chemically reacted with the shell-forming chemicals 12A′, 12B′, 12C′. Hence these shell-forming chemical components are used up and become another component of the overall mound of the core materials. The contents of the core composition also includes the color imparting material 18′ (dye or pigment). Thus, the entire contents of the ruptured core (the mound depicted in FIG. 5) give the resulting mound of material its color. In this system, it is again the case that, to the degree that the dye and/or pigment components 18′ (1) fail to react with the core components in an intended way, (2) fail to react with the shell-forming chemicals 12A′, 12B′, 12C′ an intended way and (3) do react with the paper substrate in ways that are not desired, the quality of the image made from such toner particles is diminished.

FIG. 6 is a perspective view of the ruptured shell depicted in FIG. 5. It shows that contents of the shell shown in FIG. 5 uniformly spread over the material. The ingredients that originally formed the shell are, to some degree, used up in chemical reactions that occur once the shell is broken open. That is to say there are no actual shell fragments such as that shown in item 12′ in FIGS. 4 and 5. Rather, the same mixed ingredient system extends to the perimeter 26′ of mound. This mound of material also contains the color creating contents 18′ of the core material 14′. Thus, the presence of the shell 12′ on the center portion of the core material shown in FIGS. 4 and 5 is eliminated. But the chemical reaction(s) between the shell ingredients and the core ingredients, and especially the dye and/or pigment ingredients, can detract from the color quality of the ruptured microcapsule depicted in FIG. 6.

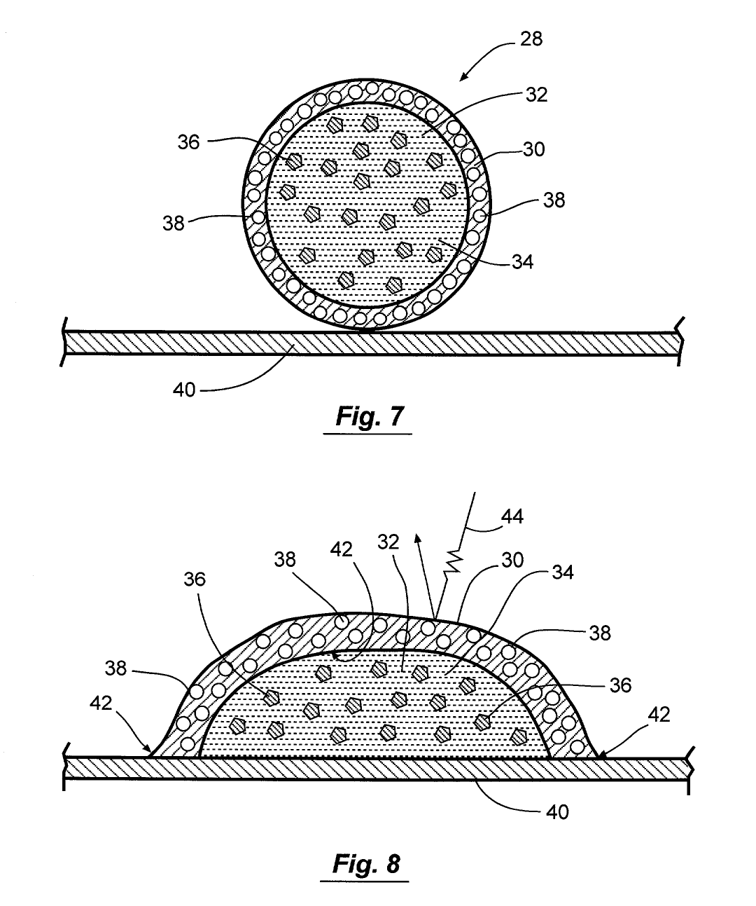

FIG. 7 depicts a side cross-sectional view of a toner microcapsule 28 made according to the teachings of this patent disclosure. The microcapsule 28 has a shell 30 that contains a core composition 32. This core composition 32 is comprised of a binder material 34 and magnetic particles 36. This microcapsule 28 differs from those prior art microcapsules depicted in FIGS. 1 and 4 in that applicant's microcapsule's colorant component(s) 38 (dye, pigment) is (are) in the material from which the shell 30 is made—rather than in the core composition 32. It also should be emphasized that this depiction also is a highly generalized and idealized chemical abstraction. The colorant 38 imparts color to the material that comprises the shell 30. That is to say that the colorant materials do not exist in the form of the visibly distinct particles 38 shown in FIG. 7, but rather are a chemical component of a compound or composition (e.g., a polymer/dye compound or composition) that forms the shell 30 itself. FIG. 7 uses this physical depiction of a colorant 38 ingredient in the shell 30 in order to emphasize that the colorant(s) 38 of applicant's toner microcapsule 28 are in its shell 30 material and not its core 32, as it is in the previously discussed prior art systems. Thus, this physical representation of a chemical/optical property of the shell material helps to illustrate the point and the present invention as well.

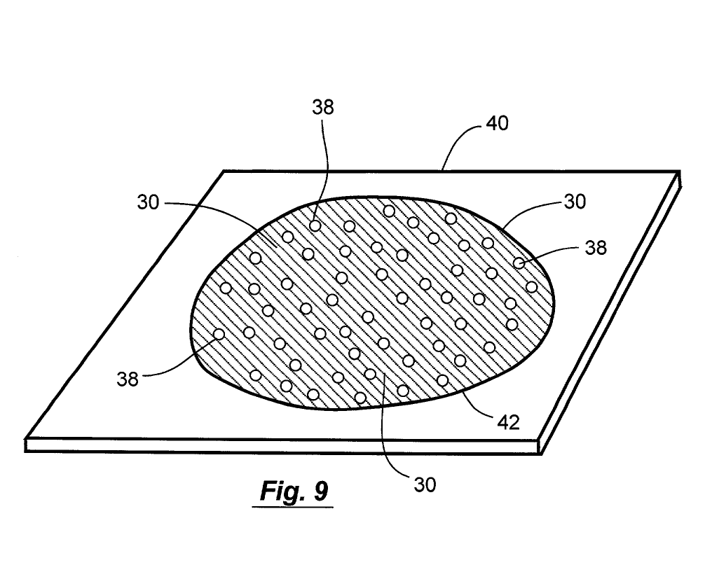

FIG. 8 depicts the results of rupturing the toner microcapsule 28 shown in FIG. 7. It shows a ruptured shell 30 (having a highly idealized hemispherical configuration) overlying a mound of the core composition 32. The core composition 32 includes a binder material 34 that, upon rupture of the shell, adheres to the substrate 40 and to the underside of the ruptured shell 30. The ruptured shell 30 is thereby affixed to the substrate 40. Thus, the color of the ruptured shell/core contents is determined by the color of the shell 30 and not by the color of (or produced by) the core materials 32 or by any chemical reactions in which they may enter. This circumstance is depicted by the reflection of a light ray 44 off of the ruptured shell 30. Thus, the color of the shell material substantially determines the color of the visual impression received by a human being from the shell/core content system.

FIG. 9 is a perspective view of the ruptured shell 30.

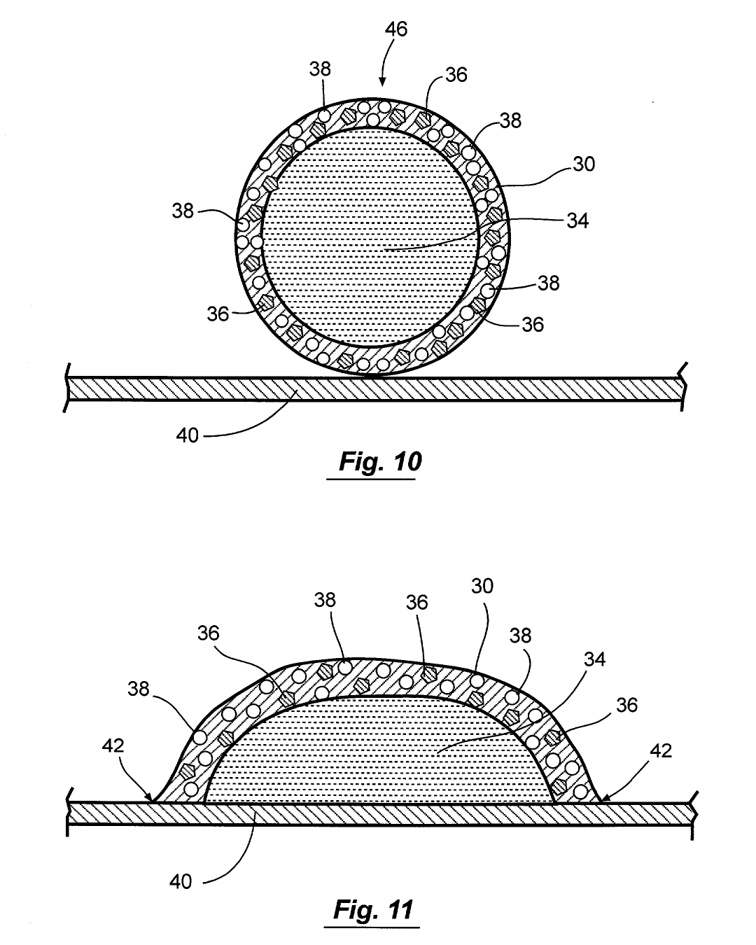

FIG. 10 is a side view of a toner microcapsule 46 whose shell 30 contains colorant 38 and magnetic particles 36. The core of the shell again contains a binder composition 34. Even though they are in the shell 30, rather than the core 32, the magnetic particles 36 still perform the same function. That is to say that the magnetic particles (in the shell) once again function to place the toner microcapsule 28 in a given place according to an electrical latent image produced by an electrophotographic printing process.

FIG. 11 depicts the toner microcapsule 46 of FIG. 10 in a ruptured state. This figure emphasizes that, even in its ruptured state, the shell 30 still determines the color of the image produced by the shell and still contains the magnetic particles 36.

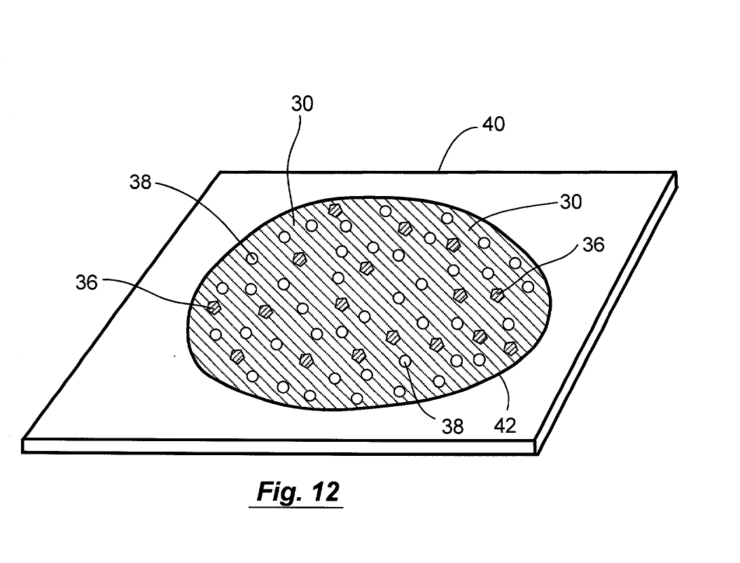

FIG. 12 is a perspective view of the ruptured toner microcapsule shown in FIG. 11. It shows a shell 30 having a mound-like configuration. The colorants 38 and magnetic particles 36 in FIG. 12 appear as if they are on top of the shell material 30. Again, this is not the case. The magnetic particles 36 are imbedded in the shell material and the colorants 38 are the chemical constituents of the shell material that determine its color.

Ingredients

Shell Ingredients

The shell component of the microcapsules of this patent disclosure will normally be polymers. A colorant will be mixed and/or chemically compounded with such polymers. Suitable polymers for the practice of this invention will include polyester, polyamide, polystyrene, polysulfonamide, polysulfonate, polycarbonate, polyether, polyethylene, polyurea, polyurethane, polythioyrethane, polythiourea, amino resin, and copolymers such as poly(styrene-methacrylate) and poly(styrene-acrylate) which are especially preferred.

The shell itself can be composed substantially of a single layer, or a complex layer system of two or more layers. For instance, the shell can comprise two or more polymers selected from the group consisting of polyurethane, polyurea and polyamide. For the purposes of this patent disclosure, such polyurethane or polyurea polymers will preferably be produced by a polycondensation reaction between a polyisocyanate and one or more counterpart compounds such as polyol, polythiol, water, polyamine and piperazine. Accordingly, the term “polyurethane” can be taken to mean either a simple polyurethane comprising substantially the urethane bondings only, or a polymer comprising the urethane bondings and a relatively small number of the urea bondings. The term “polyurea” can be taken to mean either a simple polyurea comprising substantially the urea bondings only, or a polymer comprising the urea bondings and a relatively small number of urethane bondings.

The shell polymer will preferably comprise from about 5 to about 40 percent by weight of an overall electrophotographic toner microcapsule. During an interfacial polymerization to form such a shell, the temperature will preferably be maintained at from about 20° C. to about 60° C. Generally speaking the reaction time will be from about 5 minutes to about 5 hours. Preferably, the resulting shell have an effective thickness of, for example, less than about 5 microns. Specific examples of such shells will include those comprised of the interfacial polycondensation reaction of a first polyisocyanate component and a second amine component, and wherein said toner includes an electroconductive material obtained from a water based dispersion of such a material in a polymeric binder.

Binder Materials

The core material of the microcapsules of this invention will comprise at least one binder material (adhesive material) for fixing a ruptured shell to the surface of a support medium such as paper. The binder material is preferably a liquid or semi-liquid resin upon rupture of the shell. That is to say, the core material may naturally be a liquid or semi-liquid as it resides in the shell, or it may be made into a liquid or semi-liquid by the pressure, heat, microwave, pH change, etc. produced by the force or energy form that is used to rupture the cell. Useful resins for the practice of this invention will include natural resins such as rosin (gum rosin, wood rosin, tall oil rosin), shellac, copal, dammar, gilsonite and zein; semi-synthetic resins such as hardened rosin, ester gum and other rosin esters, maleic acid resin, fumaric acid resin, dimmer rosin, polymer rosin, rosin-modified phenol resin, methyl cellulose, ethyl cellulose, hydroxyethyl cellulose, hydroxypropyl cellulose, ethyl hydroxyethyl cellulose, carboxymethyl cellulose, cellulose acetate propionate, cellulose acetate butyrate and nitrocellulose; synthetic resins such as phenolic resin, xylenic resin, urea resin, melamine resin, ketone resin, coumarone-indene resin, petroleum resin, terpene resin, cyclized rubber, rubber chloride, alkyd resin, polyamide rein, acrylic resin, polyvinyl chloride, vinyl chloride-vinyl acetate copolymer, polyvinyl acetate, ethylene-maleic anhydride copolymer, styrene-maleic anhydride copolymer, methyl vinyl ether-maleic anhydride copolymer, isobutylene-maleic anhydride copolymer, polyvinyl alcohol, modified polyvinyl alcohol, polyvinyl butyral (butyral resin), polyvinyl pyrrolidone, chlorinated polypropylene, styrene resin, epoxy resin and polyurethane.

Such resins also may include oligomers or prepolymers having an ethylenically unsaturated bond such as polyethylene glycol diacrylate, propylene glycol dimethacrylate, pentaerythritol triacrylate, trimethylolpropane diacrylate, trimethylolpropane triacrylate, pentaerythritol tetraacrylate, hexanediol diacrylate, 1,2-butanediol diacrylate, adduct of epoxy resin and acrylic acid, reaction product of acrylic acid, methacrylic acid and pentaerythritol, condensed product of maleic acid, diethylene glycol and acrylic acid, methyl methacrylate, butyl methacrylate and styrene.

Binder resins that are especially useful in the practice of this invention will include those having a polymeric component which is solid at about 15° C. and will melt below about 160° C. These binder resins will preferably comprise from about 30 to about 60 weight percent of the microcapsule.

Magnetic Particles

The magnetic particles used in the toner microcapsules of this invention may be incorporated in the core material and/or into the shell material. By way of example only, particles of ferromagnetic elements such as iron, cobalt, nickel or manganese and alloys or compounds containing these elements such as magnetite (e.g., mapico black), ferrite, etc., may be employed. Preferably, these magnetic particles will include iron oxide compounds, such as cubic iron oxide, acicular iron oxide, gamma-Fe₂O₃, and mixed crystals of gamma-Fe₂O₃ and Fe₃O₄. Such particles also may be coated with cobalt, barium ferrite, iron carbide, pure iron, and ferromagnetic allow powders such as Fe—Co and Fe—Co—Ni alloys. The size of such magnetically active particles will preferably range from about 0.1 microns to about 1.0 micron. Sizes ranging from about 0.1 to about 0.5 microns are somewhat preferred. These magnetically active particles are occluded in the shell material. The content of the magnetic particles may be 10 to 50 parts per 100 parts by weight with respect to a dry microcapsule.

Colorants

Various known dyes and/or pigments can be incorporated into the shell-forming materials. They can include: carbon black, magnetites, columbian mapico blacks and surface treated magnetites and other similar black pigments, including mixtures of these pigments with other colored pigments. Colorants that also are ferromagnetic are particularly preferred in the practice of this invention. Primary colored pigments, that is cyan, magenta, or yellow pigments, can also be selected for the shell compositions of the present invention and used according to known coloring or optical principles. Examples of particularly preferred magenta materials that may be selected as pigments for the practice of this convention include, for example, 2,9-dimethyl-substituted quinacridone and anthraquinone dye. Illustrative examples of cyan materials that may be used as pigments include copper tetra-4(octadecyl sulfonamido) phthalyocyanine, x-copper phthalocyanine pigment. Examples of yellow pigments that may be selected are diarylide yellow 3,3-dichlorobenzidene acetoacetanilides, a monoazo pigment. The aforementioned pigments can be incorporated into the shell forming compositions of the present invention in various effective amounts depending on the color desired. In one embodiment of this invention, when pigments are employed, the pigment particles will present in the shell composition in an amount of from about 2.0 percent by weight to about 20 percent by weight calculated on the weight of a dry microcapsule. When dyes are employed in the practice of this invention, they will normally comprise from about 1 weight percent to about 20 weight percent of the microcapsules. The use of both pigments and dyes are also contemplated.

Methods of Making

The electrophotographic toner microcapsules of the present invention can be prepared by a number of different processes. One of the main objects of any such process will be to provide the shell of the microcapsules with a desired color of a fixed nature. That is to say that after the colorant is used to determine the color of the shell it will not enter into any color changing chemical reactions. Thus, the processes of this patent disclosure differ from those prior art processes wherein the dyes or pigments are among the materials that are encapsulated by the encapsulation process and which may enter into color producing chemical reactions. Applicant's toner microcapsules can, for example, be made from interfacial polycondensations similar to those used to make prior art microcapsules. Applicant's versions of such processes, however, generally begin by thoroughly mixing or blending a mixture of core binder monomer or monomers, a free radical initiator, a magnetic material, and a polyisocyanate or polyisocyanates; dispersing the aforementioned well blended mixture by high shear blending into stabilized microdroplets of specific droplet size and size distribution in an aqueous medium containing a suitable stabilizer or emulsifying agents. The average volume of the microdroplets can be desirably adjusted to be from about 5.0 picoliters to about 200 picoliters. This dispersion is then subjected to a shell forming interfacial polycondensation by adding a colorant-containing polyol (or polyols). Such polyols are preferably selected from low molecular weight carbohydrates such as monosaccharides or disaccharides. Thereafter, the core binder forming free radical polymerization is initiated within the newly formed microcapsules. The shell forming interfacial polycondensation is generally executed at ambient temperature, but elevated temperatures may also be employed depending on the nature and functionality of the shell components used. Of the manufacturing methods disclosed herein, the interfacial polymerization method and the inner polymerization method are somewhat preferred.

According to another embodiment of the present invention the electrophotographic toner microcapsules are prepared by dispersing core polymers and magnetic particles, such as magnetic powder, into a colored preheated shell wall-forming material. In addition to its dye and/or pigment ingredients, the shell wall-forming material preferably will contain an oil, preferably a soybean oil, a binder resin, preferably a maleic modified rosin ester, a thixotropic agent, preferably an oxidized homopolymer polyethylene gel and an ionomer, preferably an ethylene acrylic acid ionomer, preferably sodium ionomer. The colored shell wall materials are then heated to a temperature just above their softening point (i.e., 130°-160° C.). The heating is accompanied with constant mixing until all the ingredients are melted and dissolved in the carrier, such as soybean oil. At this stage the core-forming particles are added portion-wise to the hot shell wall materials while maintaining a constant stirring. After the completion of the addition of the particles, the mixture is allowed to be mixed until a homogeneous, uniform dispersion of the iron oxide pigments in the host hot shell wall forming materials is achieved. Finally the mixture is allowed to cool to the room temperature. Upon cooling the system, the colored shell wall materials solidify and encapsulate the particles with a (hydrophobic) shell. The microcapsules produced by this process generally have a shell thickness of about 0.1 to about 0.5 microns. Such shells preferably are from about 2 to about 10 microns in diameter.

All of the toner compositions of this patent disclosure may further comprise various auxiliary agents such as capsule-protecting agents, surfactants, ultraviolet ray absorbing agents, antioxidants, photopolymerization initiators, waxes, driers, viscosity-increasing agent, gelation agents, plasticizers, desensitizers, ligand compounds and organic metal salts.

Although the preceding disclosure sets forth a number of embodiments of the present invention, those skilled in this art will appreciate that other embodiments, not precisely set forth, could be practiced under the teachings of the present invention. Therefore, the scope of this invention is limited only by the scope of the following claims.

I claim:

1. An electrophotographic toner microcapsule comprising an adhesive and a magnetizable material encapsulated in a rupturable shell that contains a colorant that substantially defines the color of an image produced by the microcapsule.

2. The electrophotographic toner microcapsule of claim 1 wherein the shell also contains a magnetizable material.

3. The electrophotographic toner microcapsule of claim 1 wherein the shell has more than one layer.

4. The electrophotographic toner microcapsule of claim 1 wherein the colorant is a ferromagnetic material.

5. The electrophotographic toner microcapsule of claim 1 wherein the microcapsule is rupturable by microwave energy.

6. The electrophotographic toner microcapsule of claim 1 wherein the shell derives its color from a dye placed in a polymer material that forms the shell.

7. The electrophotographic toner microcapsule of claim 1 wherein the shell derives its color from a pigment placed in a polymer material that forms the shell.

8. The electrophotographic toner microcapsule of claim 1 wherein the adhesive is a liquid when the shell is ruptured.

9. The electrophotographic toner microcapsule of claim 1 wherein the adhesive is a resin polymer.

10. The electrophotographic toner microcapsule of claim 1 wherein the shell is comprised of two or more polymers.

11. An electrophotographic toner microcapsule comprising an adhesive encapsulated in a rupturable shell that contains a magnetizable material and a colorant that substantially defines the color of an image produced by the microcapsule.

12. The electrophotographic toner microcapsule of claim 11 wherein the adhesive is a liquid when the shell is ruptured.

13. The electrophotographic toner microcapsule of claim 11 wherein the shell derives its color from a pigment placed in a polymer material that forms the shell.

14. The electrophotographic toner microcapsule of claim 11 wherein the shell derives its color from a dye placed in a polymer material that forms the shell.

15. The electrophotographic toner microcapsule of claim 11 wherein virtually all of the colorant is in the shell material.

16. The electrophotographic toner microcapsule of claim 11 wherein the microcapsule is rupturable by microwave energy.

17. The electrophotographic toner microcapsule of claim 11 wherein the microcapsule is rupturable by pressure.

18. An electrophotographic printing system comprising:
a plurality of microcapsules that each comprise an adhesive and a magnetizable material that are encapsulated in a rupturable, colored, shell;
a device for depositing the microcapsules in an image, on a printed medium; and
a device for rupturing the microcapsules deposited on the print medium in order to contact the adhesive with the print medium.

19. The electrophotographic printing system of claim 18 wherein the device for rupturing the microcapsules is a microwave generating device.

20. The electrophotographic printing system of claim 18 wherein the device for rupturing the microcapsules is a pressure creating device.
